(19) United States
(12) Patent Application Publication
(10) Pub. No.: US 2005/0120800 A1
(43) Pub. Date: Jun. 9, 2005

(54) Wear-proof metal screwing connecting structure

(76) Inventor: Shen Mu Kao, Tau Yuan Hsien (TW)

Correspondence Address: Shen Mu Kao, 235 Chung - Ho, Box 8-24, Taipei, TW

(21) Appl. No.: 10/730,318

(22) Filed: Dec. 4, 2003

(51) Int. Cl. G01L 7/00

(52) U.S. Cl. 73/756

(57) ABSTRACT

A wear-proof metal screwing connecting structure comprises a connecting seat having a lower end connected to a fluid tube or a container. A top end of the connecting seat has a threaded hole; and an upper periphery of the threaded hole is arranged with a rubber edge. A connecting body locks to the threaded hole and thus is enclosed by the rubber edge. An upper end of the connecting body is installed with a pressure meter; and a threaded tube extends from pressure meter. A rubber layer encloses an upper part of the threaded tube; and the lower part of the threaded tube is screwed into the threaded hole of the connecting body so as to tightly lock the connecting body to the connecting seat.

### FIELD OF THE INVENTION

The present invention relates to connecting structures, and particularly to a wear-proof metal screwing connecting structure.

### BACKGROUND OF THE INVENTION

The prior art manometers used in fluid are made of metal and is exposed in chemical wearing environment so that they are easy to be worn and thus damaged. Thereby, the prior art manometers must be maintained continuously. This induced the increment of cost and labor work.

Referring to FIG. 4, a prior art manometer is illustrated. In that a threaded tube 31 extends from a connecting body 30. The threaded tube 31 has a head 32 and a neck 33. The head 32 and neck 33 are embedded into the top end 35 of the connecting seat 34. However, this structure has a bad shock-proof ability. Moreover, a bottom 37 of the top end 35 easily breaks. Thereby, the manufacturing cost is high.

### SUMMARY OF THE INVENTION

Accordingly, the primary object of the present invention is to provide a wear-proof metal screwing connecting structure which comprises a connecting seat having a lower end for connecting to a fluid tube or a container. A top end of the connecting seat has a threaded hole; and an upper periphery of the threaded hole is arranged with a rubber edge. A connecting body locks to the threaded hole so as to be enclosed by the rubber edge. An upper end of the connecting body is installed with a pressure meter; and a threaded tube extends from pressure meter. A rubber layer encloses an upper part of the threaded tube; and the lower part of the threaded tube is screwed into the threaded hole of the connecting body so as to tightly lock the connecting body to the connecting seat.

The various objects and advantages of the present invention will be more readily understood from the following detailed description when read in conjunction with the appended drawing.

### BRIEF DESCRIPTION OF THE DRAWINGS

FIG. 1 is a front view of the present invention.

FIG. 2 is a lateral exploded view of the present invention.

FIG. 3 is a cross sectional view of the present invention.

FIG. 4 is a schematic view of the prior art structure.

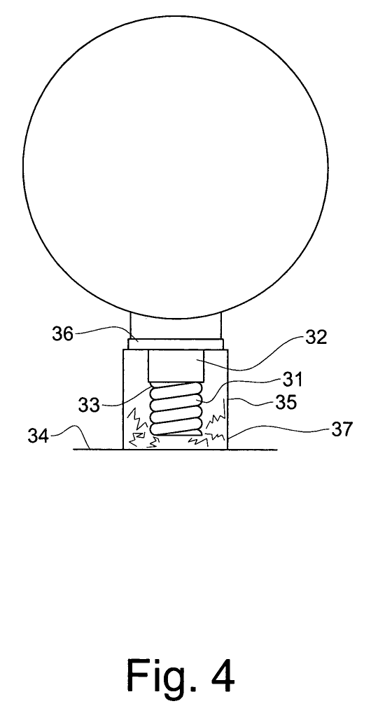

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

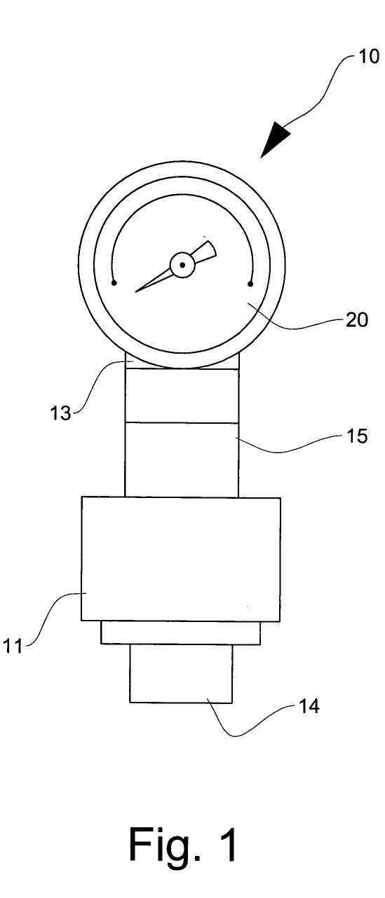

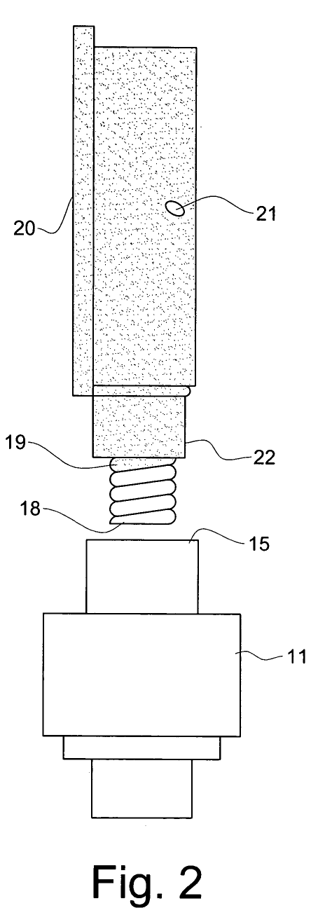

Referring to FIGS. 1, 2 and 3, the front view, lateral view and cross sectional view of the present invention are illustrated. In this embodiment, the present invention is realized in a manometer 10. The connecting structure of the present invention includes a connecting seat 11 and a connecting body 13. A lower end 14 of the connecting seat 11 is connected to a fluid tube or other container. A top end 15 of the connecting seat 11 has a screw hole 16. A rubber edge 17 is installed around an upper periphery of the screw hole 16. Thereby, the connecting seat 11 is connected to the connecting body 13. A pressure meter 20 is installed above the connecting body 13. A threaded tube 18 extends from the pressure meter 20. A rubber layer 21 encloses the threaded tube. A lower end of the rubber layer 21 extends to the head 22 and neck 19 of the threaded tube 18.

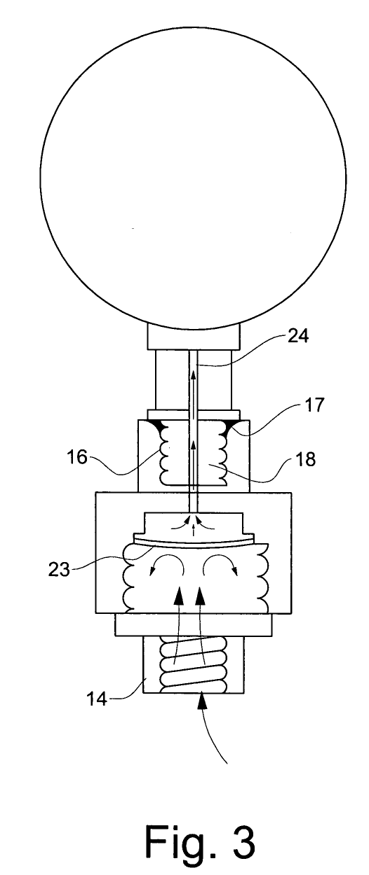

Referring to FIG. 3, a drum valve 23 is placed in the connecting seat 11. Air from a lower end of the connecting seat 11 will make the drum valve 23 to expand upwards. Then the pressure will transfer to the pressure meter 20 from the channel 24. The channel 24 is filled with air or glycerine so as to have a preferred shock-proof effect. If so, if the connecting body 13 is not tightly connected to the top end 15 of the connecting seat 11, the correction of the pressure will be effected. If crack is generated at the top end 15, then the fluid pressure cause that the drum valve 23 breaks. Thus, a dangerous condition occurs, but the present invention has no this problem because the height of the top end 15 has been reduced. The connecting body 13 and part of the threaded tube 18 are enclosed by the rubber layer 21 so that the tolerance and the availability are increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A wear-proof metal screwing connecting structure comprising:
a connecting seat; a lower end of the connecting seat being connected to a fluid tube or a container; a top end of the connecting seat having a threaded hole; an upper periphery of the threaded hole being arranged with a rubber edge;
a connecting body locked to the threaded hole and enclosed by the rubber edge; an upper end of the connecting body being installed with a pressure meter; and a threaded tube extending from pressure meter; a rubber layer enclosing an upper part of the threaded tube; and a lower part of the threaded tube being screwed into the threaded hole of the connecting body to tightly lock the connecting body to the connecting seat.
